(19) United States
(12) Patent Application Publication
(10) Pub. No.: US 2009/0016294 A1
(43) Pub. Date: Jan. 15, 2009

(54) COMMUNICATION SYSTEM, MOBILE TERMINAL, INFORMATION TERMINAL, COMMUNICATION METHOD, AND PROGRAM

(76) Inventor: Yasushi Kikkawa, Tokyo (JP)

Correspondence Address: NEC CORPORATION OF AMERICA, 6535 N. STATE HWY 161, IRVING, TX, 75039, US

(21) Appl. No.: 12/281,380

(22) PCT Filed: Feb. 27, 2007
(86) PCT No.: PCT/JP2007/053625

§ 371 Date: Sep. 2, 2008

(30) Foreign Application Priority Data
Mar. 2, 2006 (JP) 2006-055650

(51) Int. Cl. H04Q 7/38

(52) U.S. Cl. 370/329

(57) ABSTRACT

[PROBLEMS] To provide a communication system capable of switching between a terminal for making a call via a mobile telephone network and a terminal for making a call via the Internet without a bothersome operation. [MEANS FOR SOLVING PROBLEMS] A mobile terminal ((A) 1-1) is connected to the router (3) via the radio LAN function and connected to a personal computer ((A) 2-1) and the Internet network (100) via the router (3). The mobile terminal ((A) 1-1) is connected to a mobile terminal ((B) 1-2) via a mobile telephone network (200) by the radio modem. The personal computer ((A) 2-1) has a function for performing the Internet telephones via the Internet network (100) and is radio LAN-connected to the mobile terminal ((A) 1-1) via the router (3). The personal computer ((A) 2-1) controls the mobile terminal ((A) 1-1) which is radio LAN-connected via the router (3) so as to originate and receive the Internet telephone and voice communication via the mobile terminal ((A) 1-1).

### TECHNICAL FIELD

The present invention relates to a mobile terminal, an information terminal, a communication method, and a program, in particular, to a mobile terminal loaded with radio LAN (Local Area Network) function.

### BACKGROUND ART

In recent years, mobile terminals such as a mobile telephone include a terminal having radio LAN function to connect to a radio LAN in addition to the function to connect to a mobile telephone network (e.g., patent documents 1 to 3).

The mobile telephone then can be connected to the same network (Internet) as a personal computer. Recently, calls can be made via Internet such as SKYPE (registered trademark), instant message, and the like.

Thus, it has been more convenient in mobile telephones as calls can be made via mobile telephone network and via the Internet, but at the same time, it is required to manage plural telephones (for calls via mobile telephone network and calls via the Internet).

Patent document 1: Japanese Patent No. 2005-531986

Patent document 2: Japanese Laid-Open Patent Publication No. 2002-190845

Patent document 3: Japanese Laid-Open Patent Publication No. 2001-103568

### DISCLOSURE OF THE INVENTION

In the conventional mobile terminal described above, calls via the mobile telephone network and calls via the Internet become possible by loading the radio LAN function. However, when originating a call, the call needs to be made by dialing the other party's number, and it is bothersome to switch the two types of the calling methods when dialing every time. Furthermore, it is possible to receive a call via the mobile telephone network and via the Internet, by loading the radio LAN function in the conventional mobile terminal, and the presence of both originating and receiving of calls also leads to bothersome.

In order to resolve the above problems, it is an object of the present invention to provide a communication system, a mobile terminal, an information terminal, a communication method, and a program, capable of switching between a terminal for making a call via a mobile telephone network and a terminal for making a call via the Internet without a bothersome operation.

A communication system according to the present invention relates to a communication system including a mobile terminal having a radio LAN (Local Area Network) function, and an information terminal which can be radio LAN-connected to the mobile terminal, having a function of performing an Internet telephone, wherein the mobile terminal is controlled from the information terminal via the radio LAN to establish a call between the information terminal and the other party via the mobile terminal, and further, to establish a call between the information terminal and the other party by forwarding a call received at the mobile terminal to the information terminal via the radio LAN.

Another communication system according to the present, invention relates to a communication system including a mobile terminal loaded with a radio LAN (Local Area Network) function, and an information terminal which can be radio LAN-connected to the mobile terminal, having a function of performing an Internet telephone, wherein the mobile terminal is controlled from the information terminal via the Internet to establish a call between the information terminal and the other party via the mobile terminal, and further, to establish a call between the information terminal and the other party by forwarding a call received at the mobile terminal to the information terminal via the Internet.

A mobile terminal according to the present invention relates to a mobile terminal having a radio LAN (Local Area Network) function and radio LAN-connected to an information terminal. The mobile terminal relays a call between the information terminal and the other party upon receiving an instruction from the information terminal via the radio LAN, and a call between the information terminal and the other party is established by forwarding a call received at the mobile terminal to the information terminal via the radio LAN.

Another mobile terminal according to the present invention relates to a mobile terminal loaded with a radio LAN (Local Area Network) function and radio LAN-connected to an information terminal. The mobile terminal relays a call between the information terminal and the other party upon receiving an instruction from the information terminal via the Internet, and a call between the information terminal and the other party is established by forwarding a call received at the mobile terminal to the information terminal via the Internet.

A call originating/receiving control method according to the present invention relates to a call originating/receiving control method used in a mobile terminal having a radio LAN (Local Area Network) function and being radio LAN-connected to an information terminal. The mobile terminal executes a process of relaying a call between the information terminal and the other party upon receiving an instruction from the information terminal via the radio LAN, and a process of establishing a call between the information terminal and the other party by forwarding the call received at the mobile terminal to the information terminal via the radio LAN.

Another call originating/receiving control method according to the present invention relates to a call originating/receiving control method used in a mobile terminal having a radio LAN (Local Area Network) function and. being radio LAN-connected to an information terminal. The mobile terminal executes a process of relaying a call between the information terminal and the other party upon receiving an instruction from the information terminal via the Internet, and a process of establishing a call between the information terminal and the other party by forwarding the call received at the mobile terminal to the information terminal via the Internet.

A program of a call originating/receiving control method according to the present invention relates to a program of a call originating/receiving control method used in a mobile terminal having a radio LAN (Local Area Network) function and being radio LAN-connected to an information terminal. The program causes a computer to execute a process of relaying a call between the information terminal and the other party upon receiving an instruction from the information terminal via the radio LAN, and a process of establishing a call between the information terminal and the other party by forwarding the call received at the mobile terminal to the information terminal via the radio LAN.

Another program of a call originating/receiving control method according to the present invention relates to a program of a call originating/receiving control method used in a mobile terminal having a radio LAN (Local Area Network) function and being radio LAN-connected to an information terminal. The program causes a computer to execute a process of relaying a call between the information terminal and the other party upon receiving an instruction from the information terminal via the Internet, and a process of establishing a call between the information terminal and the other party by forwarding the call received at the mobile terminal to the information terminal via the Internet.

In other words, the mobile terminal of the present invention has a radio LAN (Local Area Network) function, the mobile terminal is controlled from the personal computer etc. via the radio LAN to make a call to the other party, and the call received at the mobile terminal is forwarded to the personal computer via the radio LAN to establish the call. The call can be made even at a remote location via the Internet.

In the mobile terminal of the present invention, the mobile telephone and the Internet telephone are combined, so that the call is first attempted to be established via an Internet, which is toll free, and then switch is made to the call to the mobile terminal when the other party of the call is not connected to the Internet (not logged in).

Therefore, in the mobile terminal of the present invention, switching between a terminal for making the call via the mobile telephone network and a terminal for making a call via the Internet can be carried out without a bothersome operation by loading the radio LAN and operating the mobile terminal from the personal computer via the radio LAN to originate the call, or by forwarding the call received at the mobile terminal to the personal computer via the radio LAN to establish the call.

According to the configuration and the operation described above, the present invention has an effect in that switching between a terminal for making the call via the mobile telephone network and a terminal for making the call via the Internet can be carried out without a bothersome operation.

### BEST MODE FOR CARRYING OUT THE INVENTION

Exemplary embodiments of the invention will be described with reference to the drawings. FIG. 1 is a block diagram showing a configuration of a mobile terminal according to an exemplary embodiment of the invention. In FIG. 1, the mobile terminal 1 is configured including a CPU (central processing unit) 11, a radio modem 12 and an antenna 17 for originating and receiving calls with the other party via the mobile telephone network, a radio LAN function unit 13 and an antenna 18 for originating and receiving calls with the other party via a network [e.g., Internet network, radio LAN (Local Area Network) etc.], a display unit 14, an operation unit 15, and a memory 16 for storing programs executed by the CPU 11 and information etc. used when executing the programs.

The radio modem 12 is connected with the antenna 17 for performing a normal voice communication etc., where communication is exchanged with a base station (not shown) to perform the normal voice communication. The radio LAN function unit 13 is connected with the radio LAN antenna 18 to transmit/receive electric wave to/from the radio LAN base unit (not shown), where the electric wave is transmitted to and received from the radio LAN unit to connect to the network.

The display unit 14 is a display device such as an LCD (Liquid Crystal Display) for displaying various operation contents, messages, and the like. The operation unit 15 includes a dial key and various keys such as arrow key. The memory 16 stores information on setting information and internal information (e.g., telephone directory), program executed by the CPU 11, and the like.

FIG. 2 is a block diagram showing a configuration of a personal computer according to one exemplary embodiment of the invention. In FIG. 2, the personal computer 1 is configured including a CPU (central processing unit) 21, a radio function unit 22 and an antenna 27 for originating and receiving calls with the other party via a network [e.g., Internet network, radio LAN (Local Area Network) etc.], a display unit 23, an operation unit 24, and a memory 25 for storing programs executed by the CPU 21 and information etc. used when executing the programs.

The radio LAN function unit 22 is connected with the radio LAN antenna. 27 to transmit/receive electric wave to/from the radio LAN base unit (not shown), where the electric wave is transmitted to and received from the radio LAN base unit to connect to the network.

The display unit 23 is a display device such as an LCD for displaying various operation contents, messages, and the like. The operation unit 24 includes a dial key and various keys such as arrow key. The memory 25 stores information such as setting information and internal information (e.g., telephone directory), program executed by the CPU 21, and the like.

FIG. 3 is a block diagram showing a configuration of a communication system according to one exemplary embodiment of the invention. In FIG. 3, the communication system according to the exemplary embodiment of the invention is configured by mobile terminals (A, B) 1-1, 1-2; personal computers (A, B) 2-1, 2-2; a router 3 for connecting the mobile terminal (A) 1-1 and the personal computer (A) 2-1 to an Internet network 100; the Internet network 100 connected with the router 3 and the personal computer (B) 2-2; and a mobile telephone network 200 connected with the mobile terminals (A, B) 1-1, 1-2.

The mobile terminal (A) 1-1 has a configuration shown in FIG. 1, and is connected to the router 3 via the radio LAN function unit 13 and the antenna 18, and can be connected to the personal computer (A) 2-1 and the Internet network 100 via the router 3. The mobile terminal (A) 1-1 can be connected to the mobile terminal (B) 1-2 via the mobile telephone network 200 by the radio modem 12 and the antenna 17. The mobile terminal (B) 1-2 has a configuration excluding the radio LAN function unit 13 and the antenna 18 from the configuration shown in FIG. 1, and can be connected to the mobile terminal (A) 1-1 via the mobile telephone network 200 by the radio modem 12 and the antenna 17.

The personal computer (A) 2-1 is connectable to the Internet network 100, and has a function for performing Internet telephones via the Internet network 100 and is also radio LAN-connected to the mobile terminal (A) 1-1 via the router 3. The personal computer (B) 2-2 is connectable to the Internet network 100, and has a function for performing Internet telephones via the Internet network 100.

The personal computer (A) 2-1 can control the mobile terminal (A) 1-1, which is radio LAN-connected via the router 3, so that the Internet telephone can be originated and received, and voice communication via the mobile terminal (A) 1-1 can be made.

In such configuration, from the personal computer (A) 2-1, the Internet telephone call can be made to the personal computer (B) 2-2 via the router 3 and the Internet network 100, and the mobile telephone call can be made to the mobile terminal (B) 1-2 via the router 3 and the mobile terminal (A) 1-1. In the personal computer (A) 2-1, the Internet telephone from the personal computer (B) 2-2 can be received via the router 3 and the Internet network 100, and the mobile telephone call from the mobile terminal (B) 1-2 can be received via the router 3 and the mobile terminal (A) 1-1.

Furthermore, the mobile telephone call can be forwarded to the personal computer (A) 2-1. In this case, when the mobile terminal (B) 1-2 makes a mobile telephone call to the mobile terminal (A) 1-1, the mobile terminal (A) 1-1 forwards the mobile telephone call from the mobile terminal (B) 1-2 to the personal computer (A) 2-1 to enable communication between the mobile terminal (B) 1-2 and the personal computer (A) 2-1.

FIG. 4 is a sequence flowchart showing the operation of the communication system according to one exemplary embodiment of the invention. The call originating operation from the personal computer (A) 2-1 to the mobile terminal (B) 1-2 in the communication system according to an exemplary embodiment of the present invention will be described with reference to FIG. 1 to FIG. 4.

When the personal computer (A) 2-1 sends an instruction to the mobile terminal (B) 1-2 for making a call to the mobile terminal (A) 1-1, which is radio LAN-connected via the router 3 (see al of FIG. 4), the mobile terminal (A) 1-1 performs a call originating process on the mobile terminal (B) 1-2 via the mobile telephone network 200 according to the call originating instruction from the personal computer (A) 2-1 (see a2, a3 of FIG. 4).

Upon receiving the call of the mobile terminal (A) 1-1 [incoming call from the mobile terminal (A) 1-1] and off-hooking (see a4 of FIG. 4), the mobile terminal (B) 1-2 performs voice communication to the mobile terminal (A) 1-1 (see a5 of FIG. 4). Since the mobile terminal (A) 1-1 is performing the calling process according to the calling instruction from the personal computer (A) 2-1, it forwards the voice communication from the mobile terminal (B) 1-2 as it is to the personal computer (A) 2-1 (see a6, a7 of FIG. 4). The call is then established between the mobile terminal (B) 1-2 and the personal computer (A) 2-1 (see a8 of FIG. 4).

Although not shown, when forwarding the incoming call, which is originated from the mobile terminal (B) 1-2 to the mobile terminal (A) 1-1, to the personal computer (A) 2-1, the personal computer (A) 2-1 may send an instruction to forward the incoming call from the mobile terminal (B) 1-2 to the mobile terminal (A) 1-1, which is radio LAN-connected via the router 3, so that the communication can be established between the mobile terminal (B) 1-2 and the personal computer (A) 2-1 with the process similar to the above. Furthermore, although not shown, the incoming call of the Internet telephone to the personal computer (A) 2-1 can be forwarded to the mobile terminal (A) 1-1.

FIG. 5 is a view showing a configuration of a telephone directory of the mobile terminal (A) 1-1 of FIG. 2, and FIG. 6 is a view showing a configuration of a telephone directory table of the personal computer (A) 2-1 of FIG. 3. In FIG. 5 and FIG. 6, names (“AAAAA”, “BBBBB”, . . . , “NNNNN”), mobile telephone numbers (“090-aaaa-bbbb”, “090-gggg-hhhh”, . . . , “090-oooo-pppp”), fixed telephone numbers (telephone numbers of public network) (“03-cccc-dddd”, “03-iiii-jjjjj”, . . . , “- - - ”), and Internet telephone numbers (“050-eeee-ffff”, “- - - ”, . . . , “050-ssss-tttt”) are stored in correspondence to each other in the telephone directory of the mobile terminal (A) 1-1 and the telephone directory table of the personal computer (A) 2-1.

In the above exemplary embodiment, the telephone directory of the mobile terminal (A) 1-1 and the telephone directory table of the personal computer (A) 2-1 have the same configuration, but flag information indicating whether or not a call is forwarded to the personal computer (A) 2-1 may be added to the telephone directory of the mobile terminal (A) 1-1, or flag information indicating whether or not a call is forwarded to the mobile terminal (A) 1-1 may be added to the telephone directory table of the personal computer (A) 2-1. In this case, the call can be forwarded to the radio LAN-connected destination based on the flag information. The telephone directory of the mobile terminal (A) 1-1 and the telephone directory table of the personal computer (A) 2-1 may have different configurations.

FIG. 7 is a flowchart showing a call originating process of the mobile terminal (A) 1-1 of FIG. 3, FIG. 8 is a flowchart showing a call receiving process of the mobile terminal (A) 1-1 of FIG. 3, FIG. 9 is a flowchart showing a call originating process of the personal computer (A) 2-1 of FIG. 3, and FIG. 10 is a flowchart showing a call receiving process of the personal computer (A) 2-1 of FIG. 3. The call originating process and the call receiving process of the mobile terminal (A) 1-1 and the personal computer (A) 2-1 will be described with reference to FIG. 1, FIG. 2, and FIG. 4 to FIG. 10.

The processes shown in FIG. 7 and FIG. 8 are realized by having the CPU 11 of the mobile terminal (A) 1-1 execute the program stored in the memory 16, and the processes shown in FIG. 9 and FIG. 10 are realized by having the CPU 21 of the personal computer (A) 2-1 execute the program stored in the memory 25. The calls from the mobile terminal (A) 1-1 and the personal computer (A) 2-1 are assumed to be set to prioritize the Internet telephone.

When performing the call originating process through the operation unit 15 or according to the call originating instruction from the personal computer (A) 2-1, the mobile terminal (A) 1-1 searches the telephone directory of the other party to be called (step S1 of FIG. 7), and terminates the process if the Internet telephone number of the other party is not registered (step S2 of FIG. 7) and the mobile telephone number nor the fixed telephone number are registered (step S7 of FIG. 7).

If the Internet telephone number of the other party is registered (step S2 of FIG. 5), the mobile terminal (A) 1-1 originates the call with the Internet telephone number (step S3 of FIG. 7). When connected to the other party with the Internet telephone number (step S4 of FIG. 7), the mobile terminal (A) 1-1 performs the call to the other party with the Internet telephone (steps S5, S6 of FIG. 7) until the call is finished. In this case, if the call originating instruction from the personal computer (A) 2-1 is made, the mobile terminal (A) 1-1 forwards the voice communication of the other party to the personal computer (A) 2-1 and performs the call with the other party by the Internet telephone.

If not connected to the other party with the Internet telephone (step S4 of FIG. 7), or the mobile telephone number or the fixed telephone number is registered (step S7 of FIG. 7), the mobile terminal (A) 1-1 originates the call with the mobile telephone number or the fixed telephone number (step S8 of FIG. 7). When connected to the other party with the mobile telephone number or the fixed telephone number (step S9 of FIG. 7), the mobile terminal (A) 1-1 performs the call to the other party with the mobile telephone or the fixed telephone (steps S10, S11 of FIG. 7) until the call is finished. In this case, if the call originating instruction from the personal computer (A) 2-1 is made, the mobile terminal (A) 1-1 forwards the voice communication of the other party to the personal computer (A) 2-1 and performs the call with the other party by the mobile telephone or the fixed telephone.

Upon receiving the call with one of the mobile telephone, or the fixed telephone, or the Internet telephone, the mobile terminal (A) 1-1 checks whether the personal computer (A) 2-1, which is the forwarding destination, is radio LAN-connected via the router 3 if the radio LAN call is registered and set (step S21 of FIG. 8) through the operation unit 15 or according to the instruction from the personal computer (A) 2-1 (step S22 of FIG. 8).

If the personal computer (A) 2-1, which is the forwarding destination, is radio LAN-connected, the mobile terminal (A) 1-1 forwards the receiving call (voice communication) to the personal computer (A) 2-1 which is the forwarding destination until the receiving call is finished (steps S26, S27 of FIG. 8).

If the Internet call is not registered or set (step S21 of FIG. 8), or, if the personal computer (A) 2-1 which is the forwarding destination is not radio LAN-connected (step S23 of FIG. 8), the mobile terminal (A) 1-1 checks whether the off-hook operation is performed, and terminates the process if the off-hook operation is not performed. If the off-hook operation is performed, the mobile terminal (A) 1-1 makes the call to the other party through the mobile telephone until the call is finished (steps S24, S25 of FIG. 8).

When performing the call originating process through the operation unit 24, the personal computer (A) 2-1 performs a search in the telephone directory table of the other party to be called (step S31 of FIG. 9), and terminates the process if the Internet telephone number of the other party is not registered (step S32 of FIG. 9), and the mobile telephone number nor the fixed telephone number is registered (step S37 of FIG. 9).

If the Internet telephone number of the other party is registered (step S32 of FIG. 9), the personal computer (A) 2-1 performs the call with the Internet telephone number (step S33 of FIG. 9). If connected to the other party with the Internet telephone number (step S34 of FIG. 9), the personal computer (A) 2-1 performs the call to the other party with the Internet telephone number until the call is finished (steps S35, S36 of FIG. 9).

If not connected to the other party with the Internet telephone number (S34 of FIG. 9), or the mobile telephone number is registered (step S37 of FIG. 9), the personal computer (A) 2-1 makes the call originating instruction by the mobile telephone number to the corresponding mobile terminal (A) 1-1 (step S38 of FIG. 9). When the call by the mobile telephone is forwarded to the mobile terminal (A) 1-1 (step S39 of FIG. 9), the personal computer (A) 2-1 performs the call with the other party with the mobile telephone until the call is finished (steps S40, S41 of FIG. 9).

Upon receiving the call with one of the mobile telephone, the fixed telephone, or the Internet telephone, the personal computer (A) 2-1 checks whether the mobile terminal (A) 1-1, which is the forwarding destination, is radio LAN-connected via the router 3 if the radio LAN call is registered and set (step S51 of FIG. 10) through the operation unit 24 (step S52 of FIG. 10).

If the mobile terminal (A) 1-1 which is the forwarding destination is radio LAN-connected, the personal computer (A) 2-1 forwards the receiving call (voice communication) to the mobile terminal (A) 1-1 which is the forwarding destination until the receiving call is finished (steps S56, S57 of FIG. 10).

If the radio LAN call is not registered or set (step S51 of FIG. 10), or, if the mobile terminal (A) 1-1 which is the forwarding destination is not radio LAN-connected (step S53 of FIG. 10), the personal computer (A) 2-1 checks whether the off-hook operation is performed, and terminates the process if the off-hook operation is not performed. If the off-hook operation is performed, the personal computer (A) 2-1 makes the call to the other party through the Internet telephone-until the call is finished (steps S54, S55 of FIG. 10).

Thus, in the exemplary embodiment, the radio LAN function 13 is loaded in the mobile terminal (A) 1-1, the mobile terminal (A) 1-1 is operated via radio LAN from the personal computer (A) 2-1 to originate calls, or inversely, the calls received at the mobile terminal (A) 1-1 are forwarded to the personal computer (A) 2-1 via radio LAN to realize the call, so that the switching between a terminal for making the call via the mobile telephone network 200 and a terminal for making a call via the Internet network 100 can be performed without bothersome operation.

FIG. 11 is a block diagram showing a configuration of a communication system according to another exemplary embodiment of the invention. In FIG. 11, in the communication system according to another exemplary embodiment of the invention, the configuration and the operation are similar to the communication system according to one exemplary embodiment of the invention shown in FIG. 3 other than that the mobile terminal (A) 1-1 is connected to the personal computer (A) 2-1 via the Internet network 100.

FIG. 12 is a sequence chart showing the operation of the communication system according to another exemplary embodiment of the invention. The calling operation from the personal computer (A) 2-1 to the mobile terminal (B) 1-2 in the communication system according to another exemplary embodiment of the invention will be described with reference to FIG. 11 and FIG. 12.

When the personal computer (A) 2-1 sends an instruction to call the mobile terminal (B) 1-2 to the mobile terminal (A) 1-1, which is connected via the router 3 and the Internet network 100 (see b1 of FIG. 12), the mobile terminal (A) 1-1 performs the call originating process to the mobile terminal (B) 1-2 via the mobile telephone network 200 according to the call originating instruction from the personal computer (A) 2-1 (see b2, b3 of FIG. 12).

Upon receiving the call of the mobile terminal (A) 1-1 [arriving call from the mobile terminal (A) 1-1] and off-hooking (see b4 of FIG. 12), the mobile terminal (B) 2-1 performs a voice communication to the mobile terminal (A) 1-1 (see b5 of FIG. 12). Since the mobile terminal (A) 1-1 is performing the call originating process according to the call originating instruction from the personal computer (A) 1-1, it forwards the voice communication from the mobile terminal (B) 1-2 as it is to the personal computer (A) 2-1 (see b6, b7 of FIG. 12). The call is then established between the mobile terminal (B) 1-2 and the personal computer (A) 1-2 (see b8 of FIG. 12).

Therefore, in the exemplary embodiment, the mobile terminal (A) 1-1 is operated via radio LAN from the personal computer (A) 2-1 to originate calls, or to forward the calls received at the mobile terminal (A) 1-1 to the personal computer (A) 2-1 via radio LAN to realize the call, so that the switching between a terminal for making a call via the mobile telephone network 200 and a terminal for making a call via the Internet network 100 can be performed without bothersome operation, similar to the communication system according to one exemplary embodiment of the invention described above. Furthermore, in the exemplary embodiment, the operation and the forwarding are possible even at outside the communication range of the radio LAN, that is, even if the personal computer (A) 2-1 and the mobile terminal (A) 1-1 are at remote locations from each other.

The present invention has been described on the mobile terminals (A, B) 1-1, 1-2 and the personal computers (A, B) 2-1, 2-2 in each exemplary embodiment, but mobile telephones, PHS (Personal Handy-phone System), PDAs (Personal Digital Assistant) and the like can be used as the mobile terminals as long as the mobile telephone function and the radio LAN function can be loaded, and information terminal such as work station other than the personal computer can be used as long as the Internet telephone function and the radio LAN function can be loaded.

### BRIEF DESCRIPTION OF THE DRAWINGS

FIG. 1 is a block diagram showing a configuration of a mobile terminal according to one exemplary embodiment of the invention;

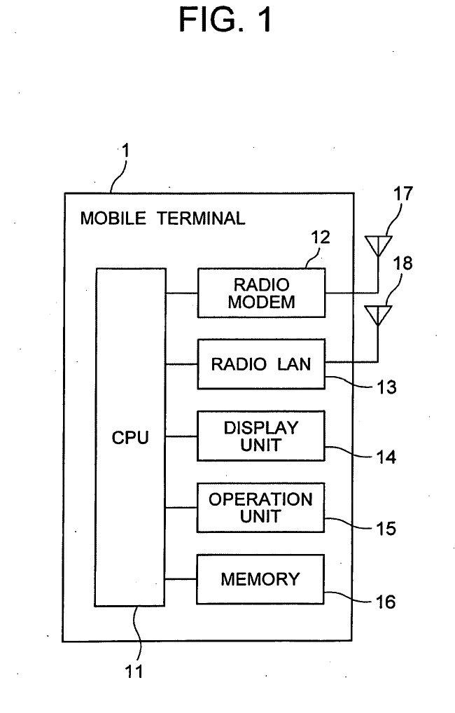

FIG. 2 is a block diagram showing a configuration of a mobile terminal according to one exemplary embodiment of the invention;

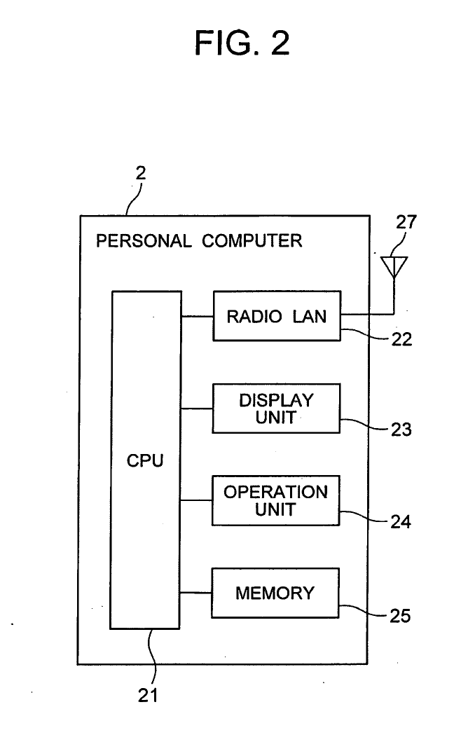

FIG. 3 is a block diagram showing a configuration of a communication system according to one exemplary embodiment of the invention;

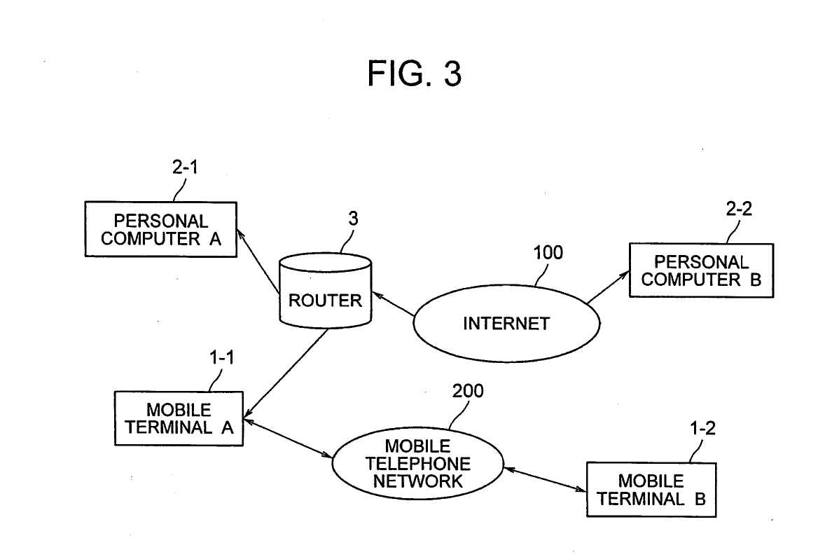

FIG. 4 is a sequence chart showing an operation of the communication system according to one exemplary embodiment of the invention;

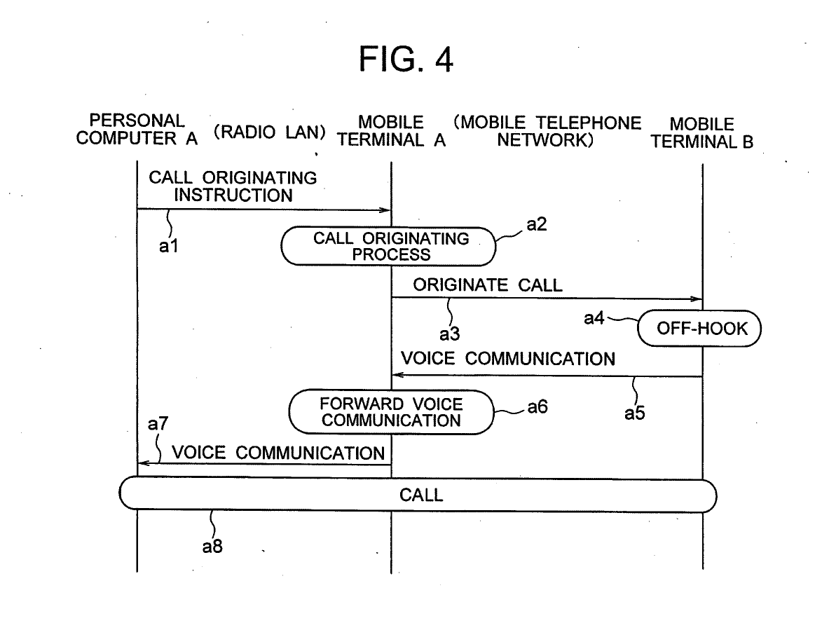

FIG. 5 is a view showing a configuration of a telephone directory of the mobile terminal of FIG. 3;

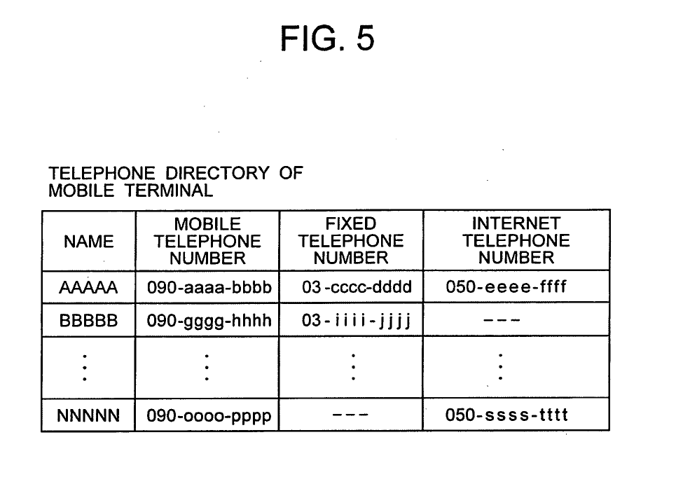

FIG. 6 is a view showing a configuration of a telephone directory table of the personal computer of FIG. 3;

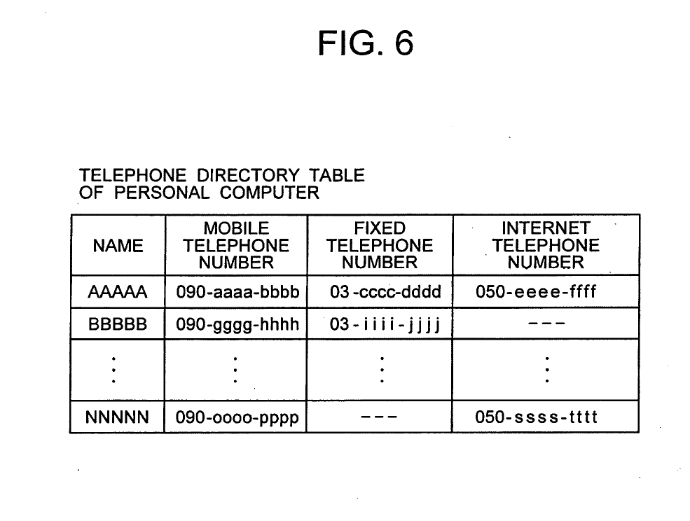

FIG. 7 is a flowchart showing a call originating process of the mobile terminal of FIG. 3;

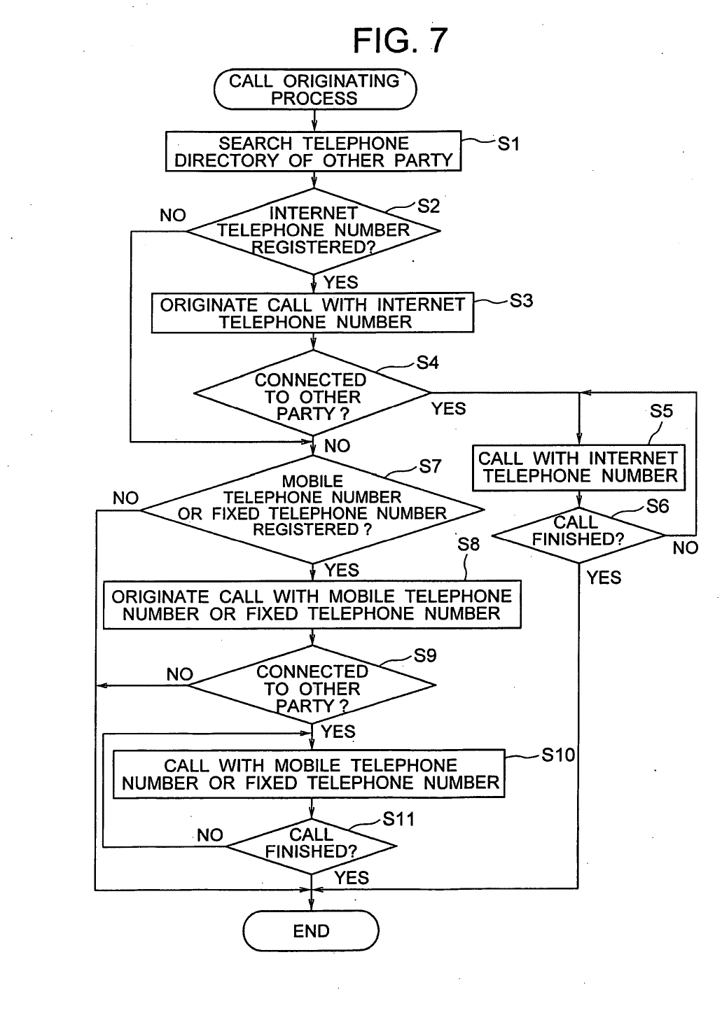

FIG. 8 is a flowchart showing a call receiving process of the mobile terminal of FIG. 3;

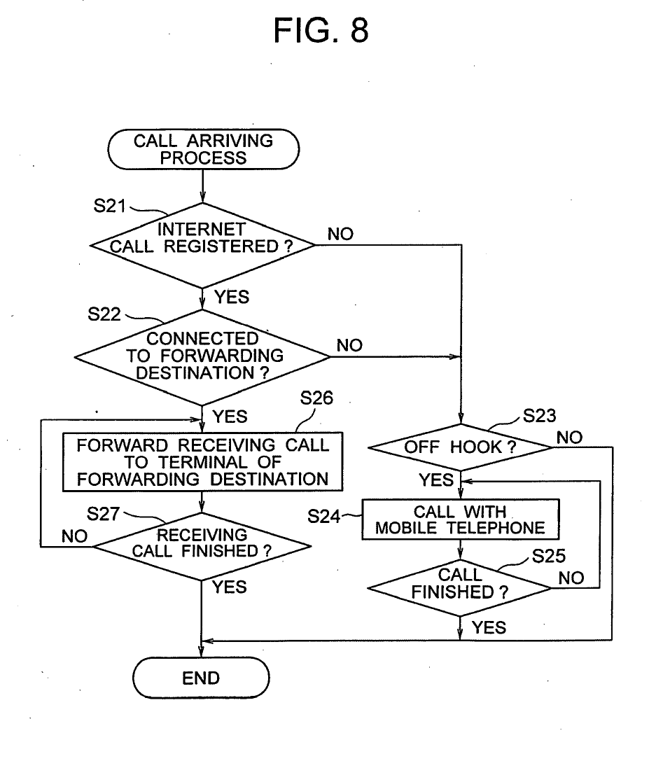

FIG. 9 is a flowchart showing a call originating process of the personal computer of FIG. 3;

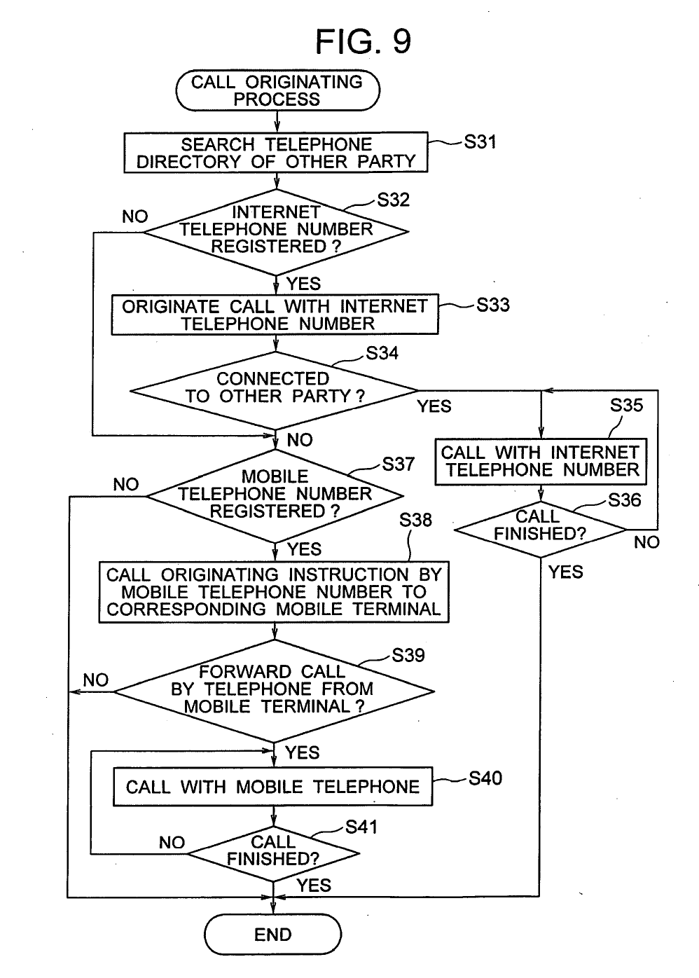

FIG. 10 is a flowchart showing a call receiving process of the personal computer of FIG. 3;

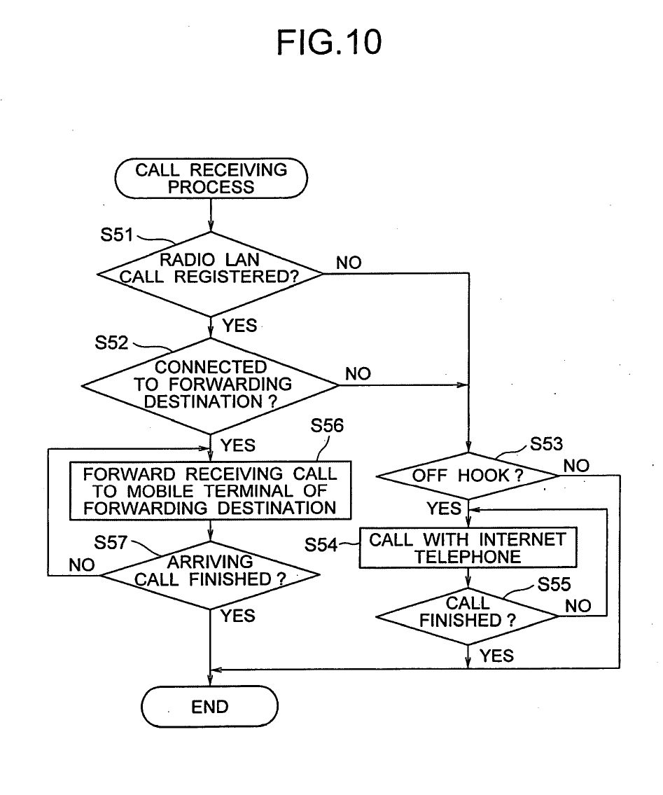

FIG. 11 is a block diagram showing a configuration of a communication system according to another exemplary embodiment of the invention; and

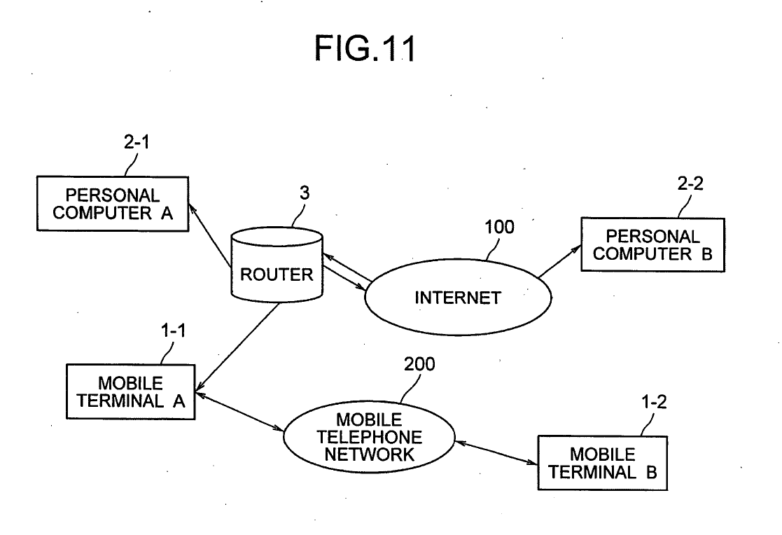

FIG. 12 is a sequence chart showing an operation of the communication system according to another exemplary embodiment of the invention.

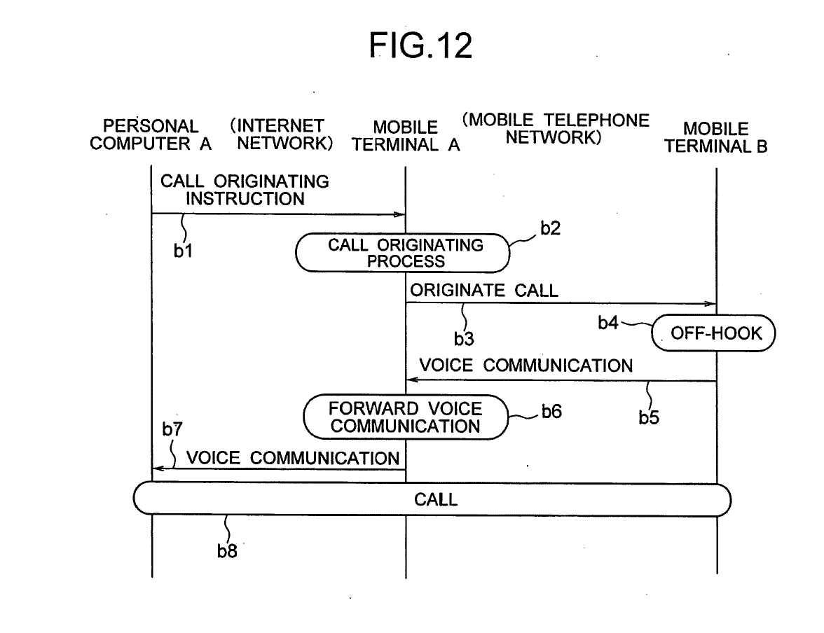

### DESCRIPTION OF SYMBOLS

1 mobile terminal

1-1 mobile terminal (A)

1-2 mobile terminal (B)

2-1 personal computer (A)

2-2 personal computer (B)

3 router

11, 21 CPU

12 radio modem

13, 22 radio LAN function

14, 23 display unit

15, 24 operation unit

16, 25 memory

17, 18, 27 antenna

100 Internet network

200 mobile telephone network

1. A communication system enabling communication between a mobile terminal and an information terminal; the communication system comprising:
a mobile terminal having a radio LAN-connecting function;
an information terminal having a radio LAN-connecting function;
a mobile telephone network for connecting the mobile terminals; and
a network for connecting the information terminals; wherein
the mobile terminal is connected to the information terminal via radio LAN; and
the information terminal controls the mobile terminal via the radio LAN to be connected to the mobile terminal of other party via the mobile telephone network.

2. The communication system according to claim 1, wherein
the information terminal makes a call originating instruction to the radio LAN-connected mobile terminal; and
the mobile terminal makes a call originating instruction to the mobile terminal of the other party via the mobile telephone network based on the call originating instruction from the information terminal.

3. The communication system according to claim 1, wherein the information terminal is radio LAN-connected to the mobile terminal via a router.

4. The communication system according to claim 1, wherein the information terminal is radio LAN-connected to the mobile terminal via a router and the network.

5. A mobile terminal used in a communication system for performing communication with an information terminal, the mobile terminal comprising:
a radio modem; and
a radio LAN function unit; wherein
the radio modem connects the mobile terminals to a mobile telephone network; and
the radio LAN function unit connects the mobile terminal to the information terminal.

6. The mobile terminal according to claim 5, wherein the mobile terminal makes a call originating instruction to a mobile terminal of the other party via the mobile telephone network based on a call originating instruction from the information terminal.

7. The mobile terminal according to claim 5, wherein the mobile terminal is radio LAN-connected to the information terminal via a router.

8. The mobile terminal according to claim 5, wherein the mobile terminal is radio LAN-connected to the information terminal via a router and a network.

9. An information terminal used in a communication system for performing communication with a mobile terminal, the information terminal comprising:
a radio modem; and
a radio LAN function unit; wherein
the radio modem connects the information terminals to a network; and
the radio LAN function unit connects the information terminal to the mobile terminal.

10. The information terminal according to claim 9, wherein the information terminal makes a call originating instruction to the mobile terminal.

11. The information terminal according to claim 9, wherein the information terminal is radio LAN-connected to the mobile terminal via a router.

12. The information terminal according to claim 9, wherein the information terminal is radio LAN-connected to the mobile terminal via a router and the network.

13. A communication method for performing communication between a mobile terminal and an information terminal; the method comprising:
connecting the mobile terminal and the information terminal via radio LAN; and
controlling the mobile terminal with the information terminal via radio LAN to connect a mobile terminal of other party and the information terminal via a mobile telephone network.

14. The communication method according to claim 13, further comprising:
making a call originating instruction from the radio LAN-connected information terminal to the mobile terminal; and
relaying the mobile terminal activated based on the call originating instruction to ensure a communication path via the mobile telephone network between the information terminal and the mobile terminal of the other party.

15. A computer readable medium storing a program of a call originating/receiving control method used in a mobile terminal having a radio LAN (Local Area Network) function and being radio LAN-connected to an information terminal; the program causing a computer to execute a process of relaying a call between the information terminal and other party upon receiving an instruction from the information terminal via the radio LAN, and a process of establishing a call between the information terminal and the other party by forwarding the call received at the mobile terminal to the information terminal via the radio LAN.

16. A computer readable medium storing a program of a call originating/receiving control method used in a mobile terminal having a radio LAN (Local Area Network) function and being radio LAN-connected to an information terminal; the program causing a computer to execute a process of relaying a call between the information terminal and other party upon receiving an instruction from the information terminal via Internet, and a process of establishing a call between the information terminal and the other party by forwarding the call received at the mobile terminal to the information terminal via the Internet.
